(19) United States
(12) Patent Application Publication
(10) Pub. No.: US 2004/0175158 A1
(43) Pub. Date: Sep. 9, 2004

(54) OPTICAL DISC WITH UNIQUE FILE STRUCTURE AND METHOD FOR CREATING SAME

(76) Inventor: Allen Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,364

(22) Filed: Feb. 26, 2004

(30) Foreign Application Priority Data
Mar. 5, 2003 (TW) 092104753

(51) Int. Cl. H04N 5/781

(52) U.S. Cl. 386/125; 386/126

(57) ABSTRACT

An optical disc with unique file structure used in a disc player and a method creating the same. The file structure of the optical disc that can be played by a disc player has an additional folder, which stores a plurality of original picture files. In this way, the optical disc has a folder storing MPEG decoded picture files that can be played by the disc player and another folder storing the original picture files that can be shown by a computer.

### BACKGROUND OF INVENTION

1. Field of the Invention

The present invention relates to an optical disc, and in particular to an optical disk having a file structure used in a disc player and a method creating the same.

2. Description of the Prior Art

As the development of the technologies, video players have made a great progress from video tape players to laser disc (LD) players. Today, the VCD players and DVD players are the mainstream in the player market. Furthermore, because of the development of multimedia and computer technologies, a lot of digital video data or digital audio video (AV) data is obtained easily by using a personal computer connecting to AV sources such as video camera, digital camera, scanner and so on. By using a specific software having functions of editing, encoding and recording installed in the personal computer and an optical recorder, the digital video data or digital AV data can be edited and encoded into files of specific format, such as moving picture experts group (MPEG) files. And then, these files are recorded onto an optical disc and can be played by DVD or VCD players. This kind of optical discs is compatible with the specifications of DVD or VCD and can be regarded as optical discs used in disc players.

Today, there are also some special players sold in the market having functions of editing, encoding and recording. Digital video data or digital audio video data can be received directly by this kind of players. The received data then is showed on the TV screen and edited by user. After edited the data, it can be encoded and recorded onto the optical disc. This kind of optical discs is also compatible with the specifications of DVD or VCD and can be regarded as optical discs used in disc players.

Referring to FIG. 1, the file structure of a VCD disc is depicted. According to the specification of VCD, the file structure may have CDI, SEGMENT, EXT, MPAGAV, and VCD folders.

CDI: The folder stores CD-i (Compact Disc Interactive) application programs and files that can be used by CD-i player.

SEGMENT: The folder stores all static MPEG encoded files.

EXT: The folder stores documents of player sequence descriptor. These documents are essential for playing the files stored in the SEGMENT folder.

MPEGAV: The folder stores all dynamic MPEG encoded files.

VCD: The folder stores documents in the video CD information area.

Because the digital cameras and scanners are now in widespread use, the optical discs are also the main storage device for the digital pictures. These original picture files have the suffixes of JPG, BMP or GIF. In order to play the digital pictures on TV screen by VCD players, these digital pictures should be encoded to the specific format. For example, these digital pictures are encoded according to MPEG encoding rule. Then, the MPEG encoded pictures are recorded into the SEGMENT folder on the optical disc. As shown in FIG. 1, ITEM0001.DAT, ITEM0002.DAT . . . and ITEM1980.DAT in the SEGMENT folder are MPEG encoded picture files (static MPEG encoded files). In this way, VCD player can play these MPEG encoded pictures by reading files stored in the SEGMENT folder.

However, this kind of optical discs recorded by personal computers or special players only can be played by VCD or DVD players. If someone wants to watch these MPEG encoded picture files by inserting this kind of discs into a disc drive of a personal computer, he or she should further purchase and install software being capable of playing VCD or DVD discs.

Furthermore, the MPEG encoded picture files stored in the SEGMENT folder are all encoded by a procedure of compression. Distortion occurs compared with these MPEG encoded picture files with the original picture files. If someone watches the MPEG encoded picture files by a personal computer, he or she should endure the bad quality showed on the screen.

### SUMMARY OF INVENTION

It is an object of the present invention to provide an optical disk with unique file structure used in a disc player and a method creating the same. When user has to play the optical discs used in disc player by using a computer, pictures with no distortion can be showed on the screen of a personal computer.

The present invention provides an optical disc with unique a file structure used in a disc player, comprising: a first folder storing a plurality of MPEG encoded picture files; and a second folder storing a plurality of original picture files; wherein the files stored in the first folder can be played by the disc player and the files stored in the second folder can be showed by a computer.

The present invention further provides a method for creating a disk with unique file structure used in a disc player, comprising the steps of: creating a first folder for storing a plurality of MPEG encoded picture files; and creating a second folder for storing a plurality of original picture files; wherein the files stored in the first folder can be played by the disc player and the files stored in the second folder can be showed by a computer.

### BRIEF DESCRIPTION OF DRAWINGS

The present invention can be fully understood from the following detailed description and preferred embodiment with reference to the accompanying drawings in which:

FIG. 1 shows a file structure of a VCD disc; and

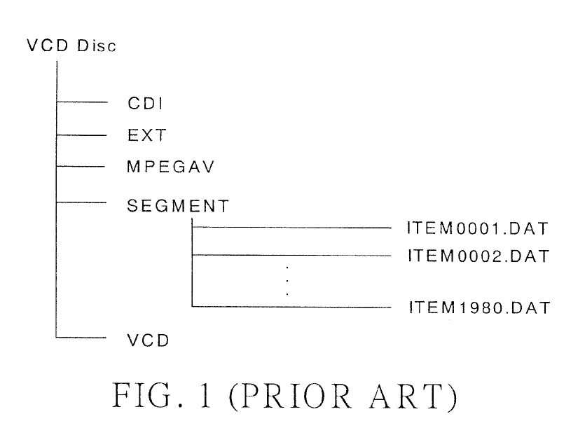

FIG. 2 shows a new file structure of an optical disc used in a disc player.

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

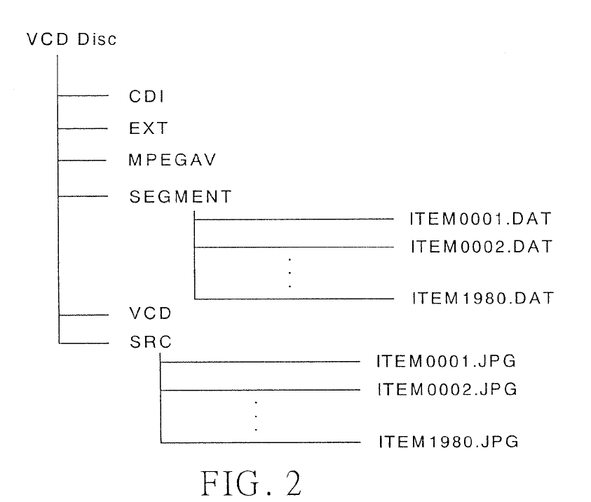

FIG. 2 shows the file structure of the present invention. According to the embodiment, the optical disc used in disc player has a further SRC folder. The original picture files having suffix of JPG (ITEM0001.JPG, ITEM0002.JPG . . . ITEM1980.JPG) are stored in the SRC folder. The MPGE encoded picture files (ITEM0001.DAT, ITEM0002.DAT . . . ITEM1980.DAT) that are encoded by computer or special player are stored in the SEGMANT folder.

When record an optical disc used in disc player, the specific software installed in a personal computer or the special player is capable of creating an additional folder (SRC) to store the original picture files. In this way, this kind of discs has two separate folders SEGMENT and SRC to store MPEG encoded picture files and original picture files. Also, this kind of optical discs having an additional folder is compatible with the specifications of VCD. When insert the optical discs of the present invention to the disc player, the disc player can play the MPGE encoded picture files on TV screen by reading the files stored in the SEGMENT folder. When insert the optical discs of the present invention to the personal computer, the user can search the original picture files stored in the SRC folder and show them on the screen of computer.

According to the present invention, the file structure of the optical discs not only can be played by disc players but also can be showed by computers with no distortion. In this way, the problem that user should purchase software being capable of playing VCD or DVD discs and endures bad quality of pictures is solved.

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. An optical disc with a file structure used in a disc player, comprising:
a first folder for storing a plurality of MPEG encoded picture files; and
a second folder for storing a plurality of original picture files;
wherein said files stored in said first folder can be played by said disc player and said files stored in said second folder can be showed by a computer.

2. The optical disc as claimed in claim 1, wherein each MPEG encoded picture file stored in said first folder has a corresponding original picture file stored in said second folder.

3. The optical disc as claimed in claim 1, wherein said original picture files have the suffixes of JPG, BMP or GIF.

4. The optical disc as claimed in claim 1, wherein said disc player is a DVD player or a VCD player.

5. The optical disc as claimed in claim 1, wherein said optical disc is recorded by a personal computer, which includes an optical recorder and an installed software.

6. The optical disc as claimed in claim 5, wherein said installed software has functions of editing, encoding and recording said original picture files.

7. The optical disc as claimed in claim 1, wherein said optical disc is recorded by a recordable player, which includes an optical recorder and an embedded software having functions of editing, encoding and recording said original picture files.

8. A method for creating an optical disc with a file structure used in a disc player, comprising the steps of:
creating a first folder for storing a plurality of MPEG encoded picture files; and
creating a second folder for storing a plurality of original picture files;
wherein said files stored in said first folder can be played by said disc player and said files stored in said second folder can be showed by a computer.

9. The method as claimed in claim 8, wherein each MPEG encoded picture file stored in said first folder has a corresponding original picture file stored in said second folder.

10. The method as claimed in claim 8, wherein said original picture files have the suffixes of JPG, BMP or GIF.

11. The method as claimed in claim 8, wherein said disc player is a DVD player or a VCD player.

12. The method as claimed in claim 8, wherein said optical disc is recorded by a personal computer.

13. The method as claimed in claim 8, wherein said optical disc is recorded by a special player.
